(19) United States
(12) Patent Application Publication
(10) Pub. No.: US 2004/0229996 A1
(43) Pub. Date: Nov. 18, 2004

(54) Polyurethane composition for the production of foils

(76) Inventors: Peter Gansen, Seeburg (DE); Guido Hagel, Duderstadt (DE)

Correspondence Address: Whitham, Curtis & Christofferson, P.C., Suite 340, 11491 Sunset Hills Road, Reston, VA, 20190, US

(21) Appl. No.: 10/792,269

(22) Filed: Mar. 4, 2004

(30) Foreign Application Priority Data
Mar. 18, 2003 (DE) 103 12 063.7

(51) Int. Cl. C08L 75/00

(52) U.S. Cl. 524/779

(57) ABSTRACT

The sprayed polyurethane foil can be demolded rapidly and easily, and has very good tensile strain at break and tear propagation resistance. In essence, the improvements in properties are brought about via a proportion of fumed silica and the omission of amine initiators.

The invention relates to a polyurethane composition for foil-production and foil-layering, in particular of sprayed foils, but also of cast foils, to a polyurethane foil, and also to a process for production thereof.

Polyurethane foils or polyurethane films are used industrially, for example as decorative surface materials, as protective foils, or as release foils, or for the jacketing of other plastics products, for example of foams, of polyurethanes, or of composite materials of complex structure, e.g. in cushions, panels, dashboards, etc.

In principle, it is possible for the thin polyurethane film, the thickness of which may, by way of example, be from 0.1 to 5.0 mm, to be directly applied to the product concerned, the result being a polyurethane coating. However, the film or the foil may also be separately produced, using certain polyurethane compositions. For this, the polyurethane composition is, by way of example, coated onto a belt-type substrate, and in turn peeled away from this after the polyurethane has reacted completely. The polyurethane composition may also be introduced as a thin film into a mold, and be demolded after curing. Liquid or soft materials, and in particular semirigid or flexible foams, may then be introduced into this molded foil.

An example of a method for applying this type of coating or for the production of a foil on a substrate or in a mold is spraying, the spray techniques and spray apparatus used for this purpose being known per se, the spraying of solvent-free compositions of sufficiently low viscosity being nowadays preferred for many applications, for environmental reasons, inter alia.

For the purposes of the present invention, a polyurethane composition is a mixture of the polyurethane starting materials or starting components, these being consumed by reaction within a certain reaction time to give a polymer material—by way of example, in the form of a foil. The composition is liquid to highly viscous or soft, and may be molded as desired immediately after the mixing of the reaction components. The physical and mechanical properties of the resultant material depend on the polyurethane components and, where appropriate, on the presence of other additives. Low-molecular-weight linear glycols or amines (chain extenders) form hard segments which give the material more strength or the desired property profile. Details concerning the action of crosslinking agents and of chain extenders are found in the Polyurethane Handbook (Polyurethane Handbook 2^{nd}. Edition, Hanser Publisher, Munich Vienna New York (1994) 37-47).

For the production of a foil, a polyurethane composition may be freshly prepared from all of the starting components and immediately processed with no use of prepolymers. This type of process is also termed a “one shot” process. The high content of free isocyanate groups makes one-shot systems very moisture-sensitive and therefore difficult to process. Bubbles can be produced in the foil by the water formed as a reaction product during the polyurethane reaction and the crosslinking, and these impair the quality of the foil or coating.

U.S. Pat. No. 4,695,618 discloses a polyurethane coating which is formed from an isocyanate component, inter alia MDI, and from a hardener component composed of polyols or of polyamines, glycols, and, where appropriate, a crosslinking agent composed of polyamines or alkanolamines. An attempt is made to counter the problem of water-sensitivity by adding from 1 to 20% by weight of adsorbents to adsorb moisture and carbon dioxide. The adsorbents used comprise the known prior-art drying agents (water-binding agents) calcium sulfate, calcium oxide or synthetic zeolite molecular sieves. The coating composition is not intended for the production of foils.

EP 379 246 discloses a light-resistant polyurethane film which can be produced by spraying and which is obtained from a relatively precisely specified polyurethane-forming composition, using at least one chain extender and/or crosslinking agent, in the presence of an organometallic catalytic system and of at least one amine initiator. In the case of this system, too, bubble formation can be a problem, and is promoted by the amine initiator.

The problem underlying the invention consists in finding a polyurethane composition which can be processed successfully without solvent and which gives a material which has good physical and mechanical properties and can be freely demolded within practicable demolding times. In addition, the film should not discolor in certain applications with exposure to light. Alteration with exposure to light is unacceptable in all types of decorative films in automobiles, for example those used for instrument panels or door-side panels.

The invention solves this problem by providing a polyurethane composition which comprises the following components at least some of which are stored separately:

(A) a di- or polyisocyanate

(B) a compound containing hydrogen active in a polyurethane reaction;

(C) a catalyst or a system catalyzing the polyurethane reaction;

(D) a fine-particle oxide of a metal or of a metalloid, as additive;

at a concentration above 3% by weight

(E) where appropriate, additives,

in the absence of amine initiators.

Component (A) preferably uses isocyanates in which there is no direct bonding between the isocyanate groups and an aromatic group, i.e. in particular aliphatic or alicyclic isocyanates, or associated derivatives. It is also possible to use mixtures of various isocyanates.

The aliphatic diisocyanates (A) used comprise conventional aliphatic and/or cycloaliphatic diisocyanates, such as tri-, tetra-, penta-, hexa-, and/or octamethylene diisocyanate, 2-methylpentamethylene 1,5-diisocyanate, 2-ethylbutylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate, dicyclohexylmethane 4,4′-, 2,4′-, and/or 2,2′-diisocyanate (a). Chemical modifications of these products, for example allophanates and biuretes, may also be used. Prepolymers of the specified isocyanates are particularly preferred.

By way of example, the compound of component (B) containing active hydrogen may have been selected from polyols, hydroxy-terminated PU prepolymers, polyesters. The polyether polyols used contain at least two hydrogen atoms reactive toward isocyanates, and have hydroxy values of from 20 to 400. They are obtained via polyaddition reactions of alkylene oxides, such as ethylene oxide, propylene oxide, butylene oxide, dodecyl oxide, or styrene oxide, preferably propylene oxide or ethylene oxide, onto starting compounds, such as, water, propylene glycol, ethylene glycol, glycerol, trimethylolpropane, pentaerythritol, sorbitol, or others.

In particular, concomitant use may be made of amine- or diamine-started polyether polyols in order to obtain polyurethane foils with better tear propagation resistance.

Suitable polyester polyols are the esterification products known per se and having hydroxy groups, preferably those of dihydric alcohols, such as ethylene glycol, diethylene glycol, propylene glycol, neopentyl glycol, 1,4-butanediol, 1,6-hexanediol with substoichiometric amounts of carboxylic acids which are preferably dibasic, examples being succinic acid, adipic acid, phthalic acid, tetrahydrophthalic acid, hexahydrophthalic acid, or of mixtures of these acids. Another compound which may be present is a OH-terminated chain extender or crosslinking agent with a molecular weight below 1000 and with an average functionality of from 2 to 6. However, the addition of an amine-terminated chain extender and/or crosslinking agent is not preferred. In the inventive polyurethane composition it is possible to avoid completely the use of the amine crosslinking agents or amine initiators which can promote bubble formation. Typical hydroxy-functional materials are ethylene glycol, glycerol, trimethylolpropane, 1,4-butanediol, propylene glycol, dipropylene glycol, 1,6-hexanediol, and the like; amine-functional chain extenders or amine initiators are compounds such as diethyltolylenediamine and other sterically hindered amines, as described in U.S. Pat. No. 4,218,543; phenylenediamine, 1,4-cyclohexanebis(methylamine), ethylenediamine, diethylenetriamine, N-(2-hydroxypropyl)ethylenediamine, N,N′-di(2-hydroxypropyl)ethylenediamine, piperazine and 2-methylpiperazine. It is less preferable to use alkanolamines, such as mono-, di-, and triethanolamine as crosslinking agents, or mono-, di-, and triisopropanolamine.

Preference is given to the use of hydroxy-terminated polyethers having more than 60% of primary OH groups, with no, or small amounts of, OH-functional chain extender or, respectively, crosslinking agents.

Component (A) preferably has an average functionality of from 2 to 8 in relation to the isocyanate groups, and specifically in the more restricted sense in relation to the isocyanate groups available for the polyurethane reaction. The isocyanate, or the components of the isocyanate mixture, also preferably has/have an NCO content of from 8 to 25%.

Component (B) preferably has an average functionality of from 2 to 8 in relation to the groups containing the active hydrogen, i.e. generally in relation to the OH groups. The main constituent of component (B)—generally a polyether polyol, or the contents of the component (B) mixture, moreover preferably has/have an average equivalent weight (E_{w}) of from 500 to 4000.

A bismuth catalyst, titanium catalyst, or tin catalyst may have been admixed as catalyst with the polyurethane composition. Preference is given to a catalytic system in which bismuth compounds, titanium compounds, and/or tin compounds are present, this type of system being known per se in the prior art for polyurethanes (see, for example: Polyurethane Handbook, loc. cit.). Traces of water may be present in the composition, its amount being not more than 0.3 part, based on 100 parts of component (B).

Component A is reacted with components B to E in such a way as to give an index of from 85 to 115. An index of 100 represents the mixing ratio at which the amounts of NCO groups and of groups reactive toward isocyanate are identical in the reactive mixture. An index above 100 means an excess of isocyanate. The inventive process usually uses components B to E:component A mixing ratios of from 100:10 or 100:20 to 100:80.

In an embodiment of the invention, a release agent may also be added to the reaction mixture to improve demolding. Other additives, fillers, and auxiliaries are not excluded. By way of example, dyes or pigments, light stabilizers, and other additive known to the person skilled in the art in this field may also be present.

Surprisingly, it has been found that the presence of a fine-particle oxide of a metal or of a metalloid as additive very considerably improves the physical properties, and in particular the mechanical properties, of the foil produced using the composition, thus making it possible to omit entirely the amine initiator added on previous occasions to give an adequately short demolding time, and thus at the same time reducing markedly the risk of bubble formation. The considerably improved mechanical properties resulting from the additive also make it possible to omit any crosslinking agent and/or chain extender, or to reduce the content of the same. This finding is astounding, because an adequate content of crosslinking agent had to be regarded as indispensable for the tensile properties of a thin polyurethane foil, in particular the ultimate tensile strength.

The method of addition of the additive to the reaction mixture, i.e. to the polyurethane composition, which can be further processed without solvent, may be direct addition within the mixture or prior mixing with another component. Mixtures are also in general use for other components, as is conventional in the prior art. Preference is given to processes in which a mixture of components B-E is prepared and is then reacted to completion with component A in a further step.

A fine-particle oxide of a metal or of a metalloid is an extremely finely divided oxide with a particularly large surface area, examples being those obtained by means of flame hydrolysis from salts of the metals or metalloids (fumed oxide). Fumed silica, i.e. fumed SiO₂, such as that known by the trade name Aerosil®, is particularly preferred. Fumed silica is prepared industrially via hydrolysis of silicon tetrachloride in a hydrogen/oxygen flame. The amorphous particles, which are in essence spherical, have a diameter of from about 10 to 20 nm, and are used, inter alia, as a filler for natural rubbers and synthetic rubbers, a thickener for the pharmaceutical and cosmetics industry, an auxiliary in the production of tablets and of dragées, an anti-sedimentation agent, and an agent with thixotropic action. Particular preference is given to the use of a fumed silicon dioxide hydrophobicized (at least at the surface), in particular Aerosil R 972, hydrophobicized by means of dichlorodimethylsilane, or else the Aerosils R 974, R 202, R 805, R 812, R 812 S, R 104, or R 106.

Instead of the fumed silicon dioxide, or mixed therewith, use may also be made of aluminum oxide or titanium oxide, inter alia. These oxides or mixtures of these oxides may also comprise relatively small amounts of other oxides of metals or of metalloids, and by way of example iron oxide may be present.

The invention further encompasses a process for producing a foil from the inventive polyurethane composition, which comprises spraying the composition, in one or more passes, shortly after it has been mixed, onto a smooth surface or into a mold, and allowing it to react completely. The manner of spray-application is preferably such as to give a layer thickness of from 0.1 to 5 mm, preferably from 0.1 to 2 mm. As an alternative, the foil may also be cast. It is readily possible to process the polyurethane composition of the invention in the usual way by a RIM (reaction injection molding) process, the properties obtained being just as advantageous as those obtained by the spraying process.

For the use of conventional spraying processes, such as those known hitherto for the application of coatings, and for the production of foils in urethane chemistry, and also those known for a long time for applying lacquers, for example, it is preferable in one embodiment of the invention that the viscosity of the individual components (A and B to E) is set at from 50 to 1000 mPas.

The components, or the entire composition, are preferably heated prior to processing, and specifically to from 50 to 90° C.

The components, or else the constituents of the mixture, of the polyurethane composition are preferably first combined to give two groups, premixed within the groups, and separately stored until they are processed. The first group comprises the isocyanate components (A), and the second group comprises components (B). In addition, the abovementioned additives, such as UV scavengers, antioxidants, release agents, flame retardants, etc., may also, where appropriate, be present in the first group and/or in the second group. The catalyst system is added with the other components of component B. The finely divided oxide is preferably admixed with component B, in a prior step. As an alternative to the two- or multicomponent premixing processes, the entire composition may also be premixed and stored in a cooled state with exclusion of air or under nitrogen.

The invention encompasses any polyurethane foil which comprises a finely divided oxide of a metal or of a metalloid as additive, the proportion by weight preferably being from 7 to 18%. Examples of particularly advantageous uses of the polyurethane foil are instrument panel skins, door-side panels, seats, saddles, and the like.

Examples are used below to provide further illustration of the invention:

### EXAMPLES

The following raw materials were used in the examples below:

Polyether 1:

Polyethertriol with OH value of 28, prepared via propoxylation of glycerol, followed by ethoxylation of the propoxylation product (PO:EO ratio by weight≅82:18)

Polyether 2:

Polyethertriol with OH value of 36, prepared via propoxylation of glycerol, followed by ethoxylation of the propoxylation product (PO:EO ratio by weight≅85:15)

Polyether 3:

Polyethertriol with OH value of 44, prepared via propoxylation of glycerol, followed by ethoxylation of the propoxylation product (PO:EO ratio by weight≅87:13)

Isocyanate:

Linear prepolymer based on hexamethylene diisocyanate with NCO content of 12.5% and viscosity of 5000 mPas.

Catalyst 1:

Metal catalyst in the form of a mixture of 58% of bismuth trisneodecanoate and 43% of neodecaneic acid.

Catalyst 2:

Amine catalyst based on N,N-dimethylbenzylamine.

Crosslinking Agent 1:

Dihydric alcohol with no other functional groups based on monoethylene glycol (1,2-ethanediol, MEG, ethylene glycol).

Antioxidant and Light Stabilizer:

Composed of a mixture (Tinuvin B 75) of 20% of phenolic antioxidant, 40% of UV absorber, and 40% of sterically hindered amine light stabilizer.

Zeolite Paste:

Desiccant composed of 30% of aluminum silicate zeolite in the T form or L form, pasted in 70% of castor oil. The average pore diameter of the T or L zeolite used is 4 Å.

Color Pigment Paste:

Color paste based on from 10 to 52% of color pigments (<50 μm particle size) pasted in polyethertriol (OH value=28)

Silicon dioxide 1: Hydrophobic fumed structure-modified silicon dioxide which does not bring about any substantial rise in viscosity.

Silicon dioxide 2: Hydrophobic fumed silicon dioxide used as agent with thixotropic effect.

The experiments were carried out using a conventional Hilger und Kern high-pressure spraying machine. The two components were mixed in a static mixer. The polyol pressure upstream of the static mixer was about 300 bar, and the isocyanate pressure was 200 bar. The raw material temperatures on the polyol side and on the isocyanate side were about 80° C.

The following overview shows the different results. Mixing specification 2 is used for a non-inventive comparative example.

| Mixing | 1 | 2 | 3 | 4 | 5 | 6 | 7 | 8 | 9 |
|---|---|---|---|---|---|---|---|---|---|
| specification | pts. by | pts. by | pts. by | pts. by | pts. by | pts. by | pts. by | pts. by | pts. by |
| product | wt. | wt. | wt. | wt. | wt. | wt. | wt. | wt. | wt. |
| Polyether 1 | 85 | 100 | 85 | 85 | 85 | | | | |
| Polyether 2 | | | | | | 85 | | | |
| Polyether 3 | | | | | | | 85 | 90 | 90 |
| Silicon dioxide 1 | 15 | | 15 | 15 | 15 | 15 | 15 | 10 | 10 |
| Silicon dioxide 2 | 1.5 | 1.5 | 1.5 | 1.5 | 1.5 | 1.5 | 1.5 | 1.5 | 1.5 |
| Catalyst 1 | 1.0 | 1.0 | 1.0 | 1.0 | 1.0 | 1.0 | | 1.0 | 2.0 |
| Catalyst 2 | | | | | | | 3.0 | | |
| Crosslinking agent 1 | | | 2 | 2 | 2 | | | | |
| Antioxidant and light | 1 | 1 | 1 | 1 | 1 | 1 | 1 | 1 | 1 |
| stabilizer | | | | | | | | | |
| Zeolite paste | | | | | 5 | | 5 | 5 | 5 |
| Color pigment paste | 5 | 5 | 5 | 5 | 5 | 5 | 5 | 5 | 5 |
| Isocyanate | 100: | 100: | 100: | 100: | 100: | 100: | 100: | 100: | 100: |
| (MR) | 15 | 17 | 34 | 34 | 35 | 18 | 24 | 26 | 26 |
| Index | 110 | 105 | 105 | 105 | 105 | 105 | 105 | 108 | 108 |
| Density [kg/m³] | 872 | 909 | 807 | 790 | 796 | 859 | 953 | 876 | 896 |
| Tensile strength | 593 | 828 | 282 | 2193 | 2335 | 1298 | 1603 | 1261 | 1630 |
| [kgPa] | | | | | | | | | |
| Tensile strain at | 589 | 173 | 404 | 462 | 383 | 435 | 262 | 105 | 127 |
| break [%] | | | | | | | | | |
| Tear propagation | 3.17 | 1.31 | 2.37 | 7.02 | 9.33 | 5.02 | 9.57 | 4.84 | 5.03 |
| resistance [N/mm] | | | | | | | | | |
| Shore L | 59 | 70 | 62 | 71 | 80 | 62 | 83 | 74 | 82 |
| Shore A | 43 | 48 | 59 | 52 | 67 | 45 | 74 | 52 | 70 |
| Thickness of material | 1.3 | 1.3 | 1.0 | 1.4 | 1.0 | 1.6 | 0.7 | 1.2 | 0.9 |

When the results of experiment 1 are compared with the comparative example (experiment 2), the substantial difference between the inventive foils and the prior art is seen. Concomitant use of the high proportions of the fumed silicon dioxide brings about an extraordinary improvement in the level of properties. When comparison is made with experiment 2, the tensile strain at break rises by a factor of 3, and the tear propagation resistance is more than doubled. The concomitant use of the silicon dioxide also has a favorable effect on the molding performance. When comparison is made with the comparative example, the time after which the sprayed skin can be demolded has been approximately halved.

1. A polyurethane composition for the production of foils, comprising the following components, at least some of which are stored separately:
(A) a di- or polyisocyanate
(B) a compound containing hydrogen active in a polyurethane reaction;
(C) a catalyst or a system catalyzing the polyurethane reaction;
(D) a fine-particle oxide of a metal or of a metalloid, as additive;
at a concentration above 3% by weight
(E) where appropriate, additives, in the absence of amine initiators.

2. The polyurethane composition as claimed in claim 1, wherein, in component (A), use is made of an isocyanate in which the isocyanate groups have no direct bonding to an aromatic group, in particular aliphatic or alicyclic isocyanates or associated derivatives.

3. The polyurethane composition as claimed in claim 1, wherein the compound of component (B) containing active hydrogen has been selected from polyols, in particular having more than 60% of primary OH groups.

4. The polyurethane composition as claimed in claim 1, wherein component (A) has an average functionality of from 2 to 3 and an NCO content of from 8 to 25%, and component (B) has an average functionality of from 2 to 8.

5. The polyurethane composition as claimed in claim 1, which comprises, as catalyst, a lead catalyst, bismuth catalyst, titanium catalyst, or tin catalyst, or comprises a system in which the lead compounds, bismuth compounds, titanium, compounds, and/or tin compounds are present.

6. The polyurethane composition as claimed in claim 1, which comprises traces of water, its amount being not more than 0.3 part, based on 100 parts of component (B).

7. The polyurethane composition as claimed in claim 1, which also comprises an OH-terminated chain extender or crosslinking agent with a molecular weight below 1000 and with an average functionality of from 2 to 6.

8. The polyurethane composition as claimed in claim 1, wherein the ratio between the components (A):(B-E) is from 15:100 to 40:100.

9. The polyurethane composition as claimed in claim 1, wherein the proportion by weight of component (C) is from 0.03 to 5%.

10. The polyurethane composition as claimed in claim 1, wherein the proportion by weight of component (D) is from 3 to 20%.

11. The polyurethane composition as claimed in claim 1, wherein a release agent for better demolding has also been added to the reaction mixture.

12. The polyurethane composition as claimed in claim 1, wherein the fine-particle oxide is a fumed silicon dioxide, aluminum oxide, titanium oxide or is a mixture of these oxides, in particular also with relatively small amounts of other oxides of metals or of metalloids.

13. The polyurethane composition as claimed in claim 12, wherein the fine-particle oxide is an oxide hydrophobicized at least on the surface, in particular hydrophobicized fumed silica.

14. A process for producing a foil from the polyurethane composition as claimed in claim 1, which comprises spraying the composition in one or more passes onto a smooth surface or into a mold, and permitting it to react to completion.

15. The process as claimed in claim 14, wherein the manner of spray-application is such as to give a layer thickness of from 0.1 to 5 mm, preferably from 0.1 to 3 mm, more preferably from 0.1 to 2 mm.

16. The process as claimed in claim 1, wherein the composition is sprayed using a temperature of from 40 to 90° C.

17. A polyurethane foil, which comprises a fine-particle oxide of a metal or of a metalloid, its proportion by weight preferably being from 5 to 15%.

18. The polyurethane foil as claimed in claim 17, which is obtainable from a polyurethane composition.
